(19) United States
(12) Patent Application Publication
(10) Pub. No.: US 2014/0329333 A1
(43) Pub. Date: Nov. 6, 2014

(54) MICRO-SAMPLING-SYSTEM FOR SMALL AMOUNTS OF FLUID SAMPLES FOR ANALYSIS IN THE VAPOUR PHASE

(71) Applicants: Károly Nagy, Aachen (DE); Bernd Schilling, Duisburg (DE); Alexander Plum, Shanghai (CN)

(72) Inventors: Károly Nagy, Aachen (DE); Bernd Schilling, Duisburg (DE); Alexander Plum, Shanghai (CN)

(73) Assignee: Bayer Intelleutual Property GmbH, Monheim (DE)

(21) Appl. No.: 14/239,174

(22) PCT Filed: Aug. 14, 2012
(86) PCT No.: PCT/EP2012/065881

§ 371 Date: May 28, 2014

(30) Foreign Application Priority Data
Aug. 19, 2011 (DE) 10 2011 081 287.3

(51) Int. Cl. G01N 1/22

(52) U.S. Cl. CPC G01N 1/2205
USPC 436/180; 422/513

(57) ABSTRACT

Microsampling system for small amounts of fluid samples for analysis in the vapour phase, which comprises a plurality of integrated functional units and is suitable for small sample quantities with fast reaction times.

The present invention relates to a microsampling system for fluid samples for analysis in the vapour phase.

The term fluids refers to both liquids and gases, or vapours. For full analysis in respect of their molecular composition, liquids are fully vaporized, or evaporated, and the sample converted into the gas phase is homogeneously mixed before the actual analysis, for example in the mass spectrometer. For the total evaporation of liquids, many devices are known, for example from the patent literature. US 2010/122564 A1, CN 2667484, EP 1174703 A1, US 2009/107640 A1 and JP 61180136 disclose only some of these devices.

For the analysis of fluids in the gas or vapour phase, however, very small sample quantities are generally required. In the case of a liquid initial sample, this means a sample volume in the microlitre range. The volume of the sample resulting therefrom in the gas phase is correspondingly larger than the volume of the liquid initial sample.

The small sample quantity, however, is important not only because of the economical use of the fluid from which the sample is taken. A further reason is that the sample taken from a process could contain components which are environmentally harmful, toxic or hazardous to health, so that the sample has to be disposed of properly after the analysis. This entails costs, which ought to be minimized so as to contribute to economical and environmentally friendly analysis.

When portable devices are involved, there is also a practical advantage of small amounts of sample since the containers for collecting the samples can likewise be made smaller, so that they are easier to handle and contribute to smaller dimensioning of mobile analysis devices.

Furthermore, a fast reaction time is desirable since, in production processes, it is often the case that individual components are detected by means of mass spectrometers and the control of dependent process parameters is carried out on the basis of the data. This is important particularly when the production is intended to be optimized in respect of one or more components, in order to avoid technical and economic disadvantages. For example, the occurrence of undesired byproducts may be avoided and, at the same time, the product quality may be increased, which in turn leads to low production costs.

However, the requirements for a small sample quantity and at the same time a fast reaction time seem generally conflicting, since the sample must be delivered from the site of the sampling to the evaporator and this distance cannot be made arbitrarily short, inter alia owing to the required connections and screw attachments. Furthermore, the lines cannot be arbitrarily thin owing to the risk of blockages. On the other hand, direct introduction of a small sample into the evaporator would cause a long reaction time. In addition, the line between the evaporator and the measuring device needs to be heated in order to avoid condensation in the line.

It is therefore an object of the present invention to provide a microsampling system for fluid samples, which is suitable for small sample quantities and permits fast reaction times, so that the disadvantages explained above can be avoided.

The subject-matter of the present invention is therefore a microsampling system according to claim 1 as well as advantageous embodiments according to the dependent claims. The subject-matter of the present invention is furthermore the use of the microsampling system according to the invention.

Accordingly, the present invention relates to a microsampling system for fluid samples for analysis in the vapour phase, which comprises at least the following integrated functional units:
a bypass block for delivering a controlled amount of the fluid sample to a micro-evaporator block,
a micro-evaporator block for controlled evaporation of the fluid sample,
a filter element for filtering the evaporated fluid sample,
a pressure reduction and outlet unit for controlled generation of a pressure reduction of the liquid sample evaporated in the micro-evaporator block and for discharging excess vapour, and
at least one cover.

The term “functional units” in this case means the individual elements of the apparatus, which only in combination constitute the overall microsampling system. For this reason, the terms functional element or functional module are equivalent to the term functional unit. The modular concept permits easy removal of the functional units and therefore also straightforward replacement of individual components, or cleaning or servicing thereof. The term “integrated functional units” is in this case intended to mean the compact structure of the overall system, in which the individual functional units are arranged successively in accordance with their function, and as such form a functional unit in which long paths between the individual elements, and therefore superfluous lines, attachments and connections, can be obviated. In this way, short reaction times can be ensured. The integration of the functional units likewise ensures that the individual modules have the same operating temperature during operation and there is thus no risk of condensation or fractionation of the sample. Additional temperature control by further heating elements at individual functional units may, however, additionally be provided.

The handling and preparation of very small sample quantities is made possible by the various functional units. The apparatus is designed in such a way that the individual functional units can easily be exposed and cleaned not only chemically but also mechanically, or replaced. By virtue of the microstructures of the functional elements and the predetermined flow paths of the sample, undesired fractionation of a complex sample matrix is eliminated and a constant homogeneous vapour flow is provided for the analysis.

The term “fluid samples” is intended to mean either liquid or gaseous samples. Preferably, the samples are liquid samples. The microsampling system may, however, also be used for gases.

For rapid and continuous sampling of fluids and for delivery of a controlled amount of the fluid sample to the micro-evaporator, the microsampling system comprises a bypass block. The mass flow in the bypass may be of any desired size. From this mass flow, the desired amount of sample is diverted in the direction of the micro-evaporator.

In a preferred embodiment of the microsampling system, a replaceable constriction disc is arranged between the bypass block and the micro-evaporator block. The constriction disc may be adapted to the various media of different viscosity and density, and lies directly at the entry of the micro-evaporator. This very short path can be covered rapidly by the mass flow of the sample. The high mass flow in the bypass and the short path to the micro-evaporator ensure a short reaction time. The length of the line to the bypass is therefore not critical so that further devices, for example pressure regulators, flow regulators or sensors may optionally be connected in order to achieve constant operating parameters.

The amount of fluid sample to be evaporated may be controlled by means of the pressure in the bypass. In a preferred embodiment of the microsampling system, the bypass block is configured for a pressure in the bypass of from 1.1 to 1.8 bar, preferably from 1.2 to 1.6 bar, particularly preferably from 1.3 to 1.4 bar. The pressure is adapted specifically to the fluid and the desired sample quantity. Accordingly, pressure ranges other than those mentioned above are possible depending on the sample fluid. Nevertheless, the system preferably operates with slight positive pressure in the bypass, 2 bar generally not being exceeded.

In another embodiment, the functional units are configured for fluid samples with volume flow rates of from 20 μL/min to 5 ml/min in the bypass block, the sampling being carried out continuously. In this way, a well-mixed small fluid sample quantity can be taken from a large volume flow, without the overall microsystem being compromised. In this case, the flow through the bypass block takes place continuously.

In another preferred embodiment, the micro-evaporator block of the microsampling system comprises an evaporation chamber having an inlet side and an outlet side, a microstructured deflection plate covering the evaporation chamber on the outlet side, connections for heating elements and a temperature sensor, and a sample volume flow rate ≦1 ml/min, preferably ≦100 μl/min, particularly preferably ≦10 μl/min is converted continuously therein into homogeneous vapour. The vapour is then provided for analytical purposes.

Furthermore, the microsampling system is configured for a reaction time of 3 s, preferably 2 s, particularly preferably 1 s. This is the propagation time of the mass flow from the bypass entry to the capillary entry into the screw attachment to the analysis device.

In another embodiment of the microsampling system, connections for the capillaries conveying the fluid are arranged on the bypass block. The connection of the microsampling system to the production unit to be monitored takes place via these capillaries.

In another embodiment of the microsampling system, the functional units are stacked on one another. The stacked functional units are fixed by screws. This leads to a compact structure of the microsampling system, in which the individual functional units are sequenced closely with one another and unnecessary lines or attachment pieces can be avoided.

In an alternative embodiment, the functional units are arranged as block units around the micro-evaporator block or are integrated into the micro-evaporator block as individual modules. In this case, all functional units remain separately removable, so that individual functional units can easily be taken off, serviced, replaced or cleaned, without the entire system having to be disassembled.

The central functional unit is formed by the micro-evaporator, which is preferably made of a stainless steel block. Merely the constriction disc is arranged between the evaporation chamber contained in the stainless steel block and the bypass block, so that the path between these two functional units is reduced to a minimum.

The amount of liquid sample introduced into the evaporation chamber is evaporated in a very short time. In the case of a liquid sample, the resulting vapour volume is significantly greater than the initial volume of the fluid sample. This induces a very rapid flow of vapour at the exit of the evaporation chamber and in the further functional units and connected lines.

The exit of the evaporation chamber is covered with a microstructured plate, which comprises slits, holes, pores or otherwise shaped openings on the micro scale. The microstructured plate has the function of preventing a short circuit between the entry of the evaporation chamber and the entry of the next functional unit. Furthermore, the vapour components are mixed by the microstructures in order to counteract fractionation of the individual constituents and in order to stabilize the vapour temperature as far as the next functional unit.

The micro-evaporator may be heated. To this end, heating elements and associated temperature sensors are preferably connected. A control loop ensures the necessary temperature stability. The temperature of the evaporated sample is kept constant above the boiling point of the initial fluid.

In order to avoid blockages in the further functional units, particularly in the capillaries to the analysis device, the evaporated sample must be filtered. In another embodiment, therefore, the filter element for filtering the evaporated fluid sample from the micro-evaporator block is arranged in a filter plate. The filter is preferably made of stainless steel and, depending on the sample evaporated, has pore diameters of ≦200 μm, preferably ≦20 μm, particularly preferably ≦2 μm. The filter plate is arranged on the micro-evaporator block, so that the filter plate forms a unit with the micro-evaporator block. In this way, the temperature applied to the micro-evaporator block is also transmitted to the filter plate, including the filter. Depending on the sample fluid, the filter is adapted to the fluid and can easily be replaced or cleaned.

Analysis devices generally require very low gas or vapour flow rates. The excess vapour must be discharged and condensed. To this end, the evaporated fluid sample is fed through a pressure reduction and outlet unit. In another embodiment of the microsampling system, the pressure reduction and outlet unit comprises a functional element for the pressure reduction and an outlet line. The function of the outlet unit is to keep the connection for the discharge at a high temperature, that is to say above the boiling point of the fluid, in order to avoid condensation in the outlet line. Even small amounts of condensate give rise to slight unmeasurable pressure elevations in the system, which lead to undesired noise of the measurement signal even if the condensate does not block the line. The connection for the discharge line must be oriented in such a way that the condensate can flow away without problems. A perpendicular or slightly inclined orientation is therefore preferred, but in any event <90° with respect to the angle between the vertical and the actual discharge line. The discharge connection is provided with a discharge line, which is dimensioned in such a way that the liquid drops which condense in its cold part cannot obstruct the line cross section and flow away easily by the force of gravity. The connection of the discharge line is heated.

In a particular embodiment, the functional element for the pressure reduction and the outlet line are arranged on a separate plate element. In this way, it is straightforward for this functional unit too to be separately removed, replaced and cleaned.

As an alternative, the outlet line is connected to the micro-evaporator block via a connection. In this way, it is possible to save on another separate component.

In order to avoid a further heating element, the vacuum of the connected analysis device, for example a mass spectrometer, is continued as far as the pressure reduction unit, where a suitable functional element ensures the pressure reduction. This functional element is preferably a thin capillary, a nozzle or a filter and correspondingly dimensioned, that is to say the length and the diameter of the capillary, or the pore size and thickness of the filter, are selected accordingly. Since the temperature of the outlet/pressure reduction unit is at the working temperature of the micro-evaporator and there is a vacuum after the outlet/pressure reduction unit as far as the analysis device, no condensation takes place in the line to the analysis device, which in turn operates at room temperature. A screw attachment for the capillary to the analysis device is likewise provided. If the analysis is not carried out in a vacuum, the line to the analysis device likewise needs to be heated.

The microsampling system is closed by the cover. In a further embodiment, the cover comprises an attachment possibility for a connection element for attachment to the capillary to the analysis unit. The functional units of the apparatus are held together by screws, which extend through the cover. There are optionally seals between the units. The microsampling system may in addition be externally enclosed by insulation.

In a preferred embodiment, the functional units are made of corrosion-resistant metals. Depending on the place of use and the fluids to be analysed, stainless steel is used for this purpose. Some functional units may, however, also consist of suitable plastics. In a preferred embodiment, the bypass block and the cover are made of chemically inert and thermally stable plastic.

In another aspect, the present invention relates to the use of the microsampling system for continuous sampling of small fluid quantities in combination with or as an integrated component of a device for analysis of the small fluid quantities in the vapour phase. Mass spectrometers are preferably used as the analysis devices.

### EXEMPLARY EMBODIMENTS AND FIGURES

Other advantages and advantageous configurations of the apparatus according to the invention are illustrated by the exemplary embodiments and figures and explained in the description below. It should in this case be noted that the exemplary embodiments and figures are only descriptive in nature and are not intended to restrict the invention in any way.

### EXEMPLARY EMBODIMENT

Water is used as the sample fluid. The working temperature is 180° C., the opening of the constriction disc has a diameter of 150 μm and the pressure in the bypass is 1.4 bar. With these working parameters, the reaction time (T90 time) of the microsampling system is about 3 s. This is the propagation time of the mass flow from the bypass entry as far as the capillary entry into the screw attachment to the analysis device. This reaction time is achieved with a liquid flow rate of about 100 μl/min in the direction of the micro-evaporator. The volume flow rate in the bypass can be set independently of this value, and varies in the range of about 20 μl/min to 2 ml/min.

### FIGURES

The following references are used in the figures:
1 bypass block
1a constriction disc
2 micro-evaporator block
2a microstructured plate
2b evaporation chamber
3 filter plate
3a filter element
4 pressure reduction and outlet unit
4a functional element for pressure reduction
4b outlet line
4c connection for the outlet line
4d plate element for the pressure reduction and outlet unit
5 cover
6a, 6b screw attachment for connection capillaries
7 connection element for capillary to the analysis unit
8 heating elements
9 temperature sensor
10 screws
11 stack cover

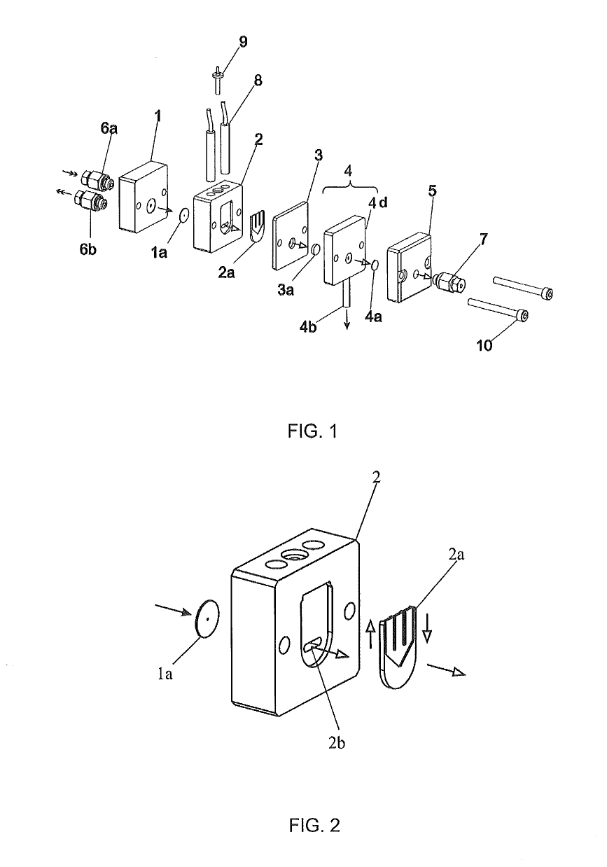

FIG. 1 schematic representation of the functional units of the microsampling system according to the invention, which are constructed in stack fashion

FIG. 2 schematic representation of the micro-evaporator block in stack structure

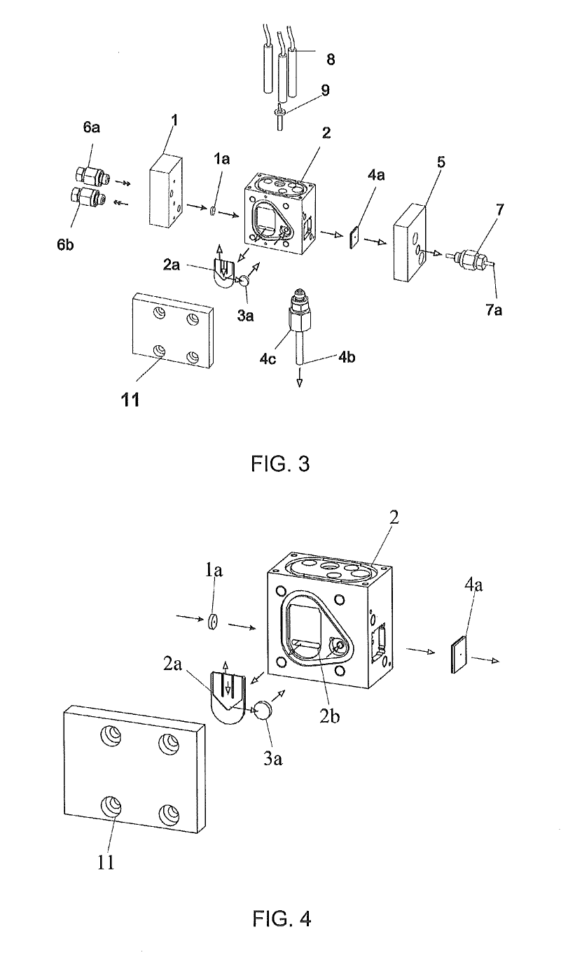

FIG. 3 schematic representation of the functional units of the microsampling system according to the invention, which are constructed in block fashion

FIG. 4 schematic representation of the micro-evaporator block in block structure

FIG. 1 shows the individual functional units of the microsampling system in the exploded state. The apparatus has a plurality of functional units, which are stacked on one another and are pressed together by screws 10. The microsampling system consists of the functional units: bypass block 1, micro-evaporator block 2, filter element 3a, pressure reduction and outlet unit 4 and cover 5. For the rapid delivery of small sample quantities to the micro-evaporator block 2, the fluid volume flow is fed through the bypass via capillaries, which are screwed to the bypass (screw attachments 6a and 6b). There may be any desired mass flow rate in the bypass.

From this mass flow, the desired small amount of sample is diverted through a constriction disc la in the direction of the micro-evaporator block 2. The arrows indicate the flow direction of the sample. The constriction disc la lies directly at the entry of the micro-evaporator block 2. The amount of liquid sample to be evaporated can be controlled by the pressure in the bypass flow. The micro-evaporator block 2 furthermore has connections for heating elements 8 and a temperature sensor 9. A microstructured plate 2a at the exit of the micro-evaporator block 2 prevents a short circuit between the entry of the evaporation chamber 2b and the entry of the next functional unit.

Furthermore, the vapour components are mixed and fractionation is thus prevented. Since the functional element 4a for the pressure reduction and the capillary to the analysis device have very small cross sections, the vapour has to be filtered in order to avoid blockages. The filter element 3a is made of stainless steel and has pore diameters <2 μm. The filter element 3a is integrated in a filter plate 3, which is pressed onto the micro-evaporator block 2 and is thereby kept at the same temperature level as the micro-evaporator block 2.

The excess vapour is discharged and condensed through the pressure reduction and outlet unit 4. The vacuum of the analysis device, a mass spectrometer, is continued as far as the pressure reduction unit 4, where a suitable functional element 4a ensures the pressure reduction. Together with the outlet line 4b, the functional element 4a for the pressure reduction is contained in a plate element 4d.

The stack structure of the microsampling system is closed by a cover 5, and the functional units of the apparatus are pressed together by screws 10. The cover 5 furthermore has a connection element 7 for the capillary to the mass spectrometer. Sealing rings may be arranged between the individual units.

FIG. 2 shows the micro-evaporator block 2 in stack structure. The micro-evaporator block 2 has a small evaporation chamber 2b, the volume of which is <100 μl. The only element between the evaporation chamber 2b and the bypass block 1 is the constriction disc 1a. The path between the two functional units is therefore reduced to a minimum, preferably <0.5 mm. The small amount of fluid sample introduced into the evaporation chamber 2b is evaporated in a very short time. The vapour volume is significantly greater than the liquid volume. This induces a very rapid flow of vapour at the exit of the evaporation chamber 2b. There is a microstructured plate 2a adjoining the exit of the evaporation chamber 2b. The path of the vapour around the microstructured plate 2a is shown by open arrows.

FIG. 3 shows an alternative structure of the microsampling system as a block. The individual functional units are arranged as block elements around the micro-evaporator block 2. The functional principle of the apparatus is identical to that in the stack structure in FIG. 1. The references of the components are likewise the same. In this concept, great importance is attached to the ability to disassemble the individual functional elements. To this end, the flow direction of the vapour in the micro-evaporator block 2 is diverted though 90°. Here again, the path of the vapour is sketched by open arrows. The vapour is directed against the microstructured plate 2a, which deviates the flow initially upwards and subsequently downwards. In a groove in the block cover 11, the flow direction of the vapour is deviated again (not shown) and guided in the direction of the filter element 3a. Through the filter element 3a, the vapour again flows into the micro-evaporator block 2. From there, after a further deviation, it is directed towards the pressure reduction unit 4. The outlet takes place through a capillary 4b, which in this case is fastened to the micro-evaporator block 2 by the screw attachment 4c. By virtue of the block structure with a deviated flow path for the vapour, all the functional units can be individually removed, replaced and cleaned.

FIG. 4 shows the micro-evaporator block 2 in block structure. The functional principle is identical to that in FIG. 3.

1-15. (canceled)

16. A microsampling system for fluid sample for analysis in the vapour phase, comprising at least the following integrated functional units:
a bypass block (1) for delivering a controlled amount of the fluid sample to a micro-evaporator block (2),
a micro-evaporator block (2) for controlled evaporation of the fluid sample,
a filter element (3a) for filtering the evaporated fluid sample,
a pressure reduction and outlet unit (4) for controlled generation of a pressure reduction of the liquid sample evaporated in the micro-evaporator block (2) and for discharging excess vapour, and
at least one cover (5).

17. The microsampling system according to claim 16, wherein a replaceable constriction disc (1a) is arranged between the bypass block (1) and the micro-evaporator block (2).

18. The microsampling system according to claim 16, wherein the bypass block (1) is configured for a pressure in the bypass of from 1.1 to 1.8 bar.

19. The microsampling system according to claim 16, wherein the micro-evaporator block (2) comprises an evaporation chamber (2b) having an inlet side and an outlet side, a microstructured deflection plate (2a) covering the evaporation chamber on the outlet side, connections for heating elements (8) and a temperature sensor (9), and a sample volume flow rate ≦1 ml/min is converted continuously therein into homogeneous vapour.

20. The microsampling system according to claim 16, wherein the system is configured for a reaction time of 3 s.

21. The microsampling system according to claim 16, wherein the functional units are stacked on one another.

22. The microsampling system according to claim 16, wherein the functional units are arranged as block units around the micro-evaporator block (2) or are integrated into the micro-evaporator block (2) and can be removed separately.

23. The microsampling system according to claim 16, wherein the filter element (3a) is arranged in a filter plate (3).

24. The microsampling system according to claim 16, wherein the pressure reduction and outlet unit (4) comprises a functional element (4a) for the pressure reduction and an outlet line (4b).

25. The microsampling system according to claim 24, wherein the functional element (4a) for the pressure reduction and the outlet line (4b) are arranged on a plate element (4d).

26. The microsampling system according to claim 24, wherein the outlet line (4b) is connected to the micro-evaporator block (2) via a connection (4c).

27. The microsampling system according to claim 16, wherein the cover (5) comprises an attachment possibility for a connection element (7) for attachment to the capillary to the analysis unit.

28. The microsampling system according to claim 16, wherein the functional units are made of corrosion-resistant metals.

29. The microsampling system according to claim 16, wherein the bypass block (2) and the cover (5) are made of chemically inert and thermally stable plastic.

30. A method for continuous sampling of small fluid quantities comprising utilizing the microsampling system according to claim 16 in combination with or as an integrated component of a device for analysis of the small fluid quantities in the vapour phase.
